(19) United States
(12) Patent Application Publication
(10) Pub. No.: US 2006/0098798 A1
(43) Pub. Date: May 11, 2006

(54) Method to selectively mute parties on a conference call

(76) Inventor: Keith G. Krasnansky, Germantown, MD (US)

Correspondence Address: TEXAS INSTRUMENTS INCORPORATED, P O BOX 655474, M/S 3999, DALLAS, TX, 75265, US

(21) Appl. No.: 10/983,861

(22) Filed: Nov. 8, 2004

(51) Int. Cl. H04M 3/42

(52) U.S. Cl. 379/202.01

(57) ABSTRACT

A method for enabling selective muting of one or a plurality of participants to a conference call. In a first embodiment, a mute control device (MCD) is interconnected with a digital, or Internet Protocol (IP) phone and a packet-based network. Protocols associated with the MCD interface with the phone and network in a manner that allows call participant identification, creates a caller-operated user interface and allows caller controlled selective muting of one or more participants connected to a call. The MCD may act as a gateway through which all packet transmission to and from each participant's phone passes or it may control an existing network gateway. The user interface may take the form of a touch screen monitor, button bank or keyboard, or the MCD may interface with the keypad of the caller's phone. In a second embodiment, the MCD may be integrated with an IP phone creating a single user device.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates to the field of conference call management. More specifically, the present invention is a method for selectively muting one or a plurality of participants to a conference call.

### BACKGROUND OF THE INVENTION

During a meeting, parties from the same company may call in from different locations creating a multi-party conference call. It is sometimes desirable to mute the telephone so that certain parties on the call do not hear a confidential conversation. At present this process mutes everyone on the call, even if some of the parties that are muted should be involved in the confidential discussion.

Presently, this problem is addressed by bringing the outside “insider” up to date at a later time, talking to them on a separate phone line, or communicating via an Internet connection. These solutions tend to be awkward and non-productive.

Various devices and protocols have been conceived which lend themselves to selective caller addition and caller drop, active-party caller ID, selective party muting and other call management features. The primary purpose of most of these features is to permit an environment that mimics multi-party, face-to-face meeting formats with the exception that some of the parties are at remote locations relative to the conductor of the meeting.

However, none of these devices or protocols lend themselves to an economical means of selectively muting one or more parties to a conference call for the purposes of implementing a private sidebar with the remaining non-muted parties.

### SUMMARY OF THE INVENTION

To address the above problem, an inventive method is disclosed which, in a first exemplary embodiment, makes use of a multi-party mute control device operatively connected to a digital telephone system through which mute management may be exercised during a conference call by the originator of such call.

The mute control device (MCD) employs telephony logic and software to interface with the caller's Internet protocol (IP) phone and a packet-based network to selectively block the transmission of audible signals to one or a plurality of muted IP telephones connected to the conference call via the network. It also manages the receipt of signals from such muted phones by all non-muted phones on the call.

The multi-party muting control method utilizes a call participant identification system which may interface with the caller ID capability of the public telephone system. The control method includes a means of user interface comprising, for example, a touch-screen selection/de-selection capability within the MCD to manage participants' involvement in the conference call. The mute control device indicates the current mute status of participants' telephones on the conference call.

In another embodiment, the mute control device allows control of the conference call via a bank of buttons, a keyboard, an associated IP phone's keypad or such other interface means.

Another embodiment has the mute control device integrated with the digital telephone as a single user device.

### BRIEF DESCRIPTION OF THE DRAWINGS

Exemplary embodiments of the invention are discussed hereinafter in reference to the following drawings, in which:

FIG. 1 is an illustration of a mute control device operatively connected to a digital (IP) telephone and to a packet-based network.

FIG. 2 is a flow diagram demonstrating the interface of a mute control device with an IP telephone and a packet-based network for a user initiating a call to a single conference call participant.

### DETAILED DESCRIPTION OF PREFERRED EXEMPLARY EMBODIMENTS

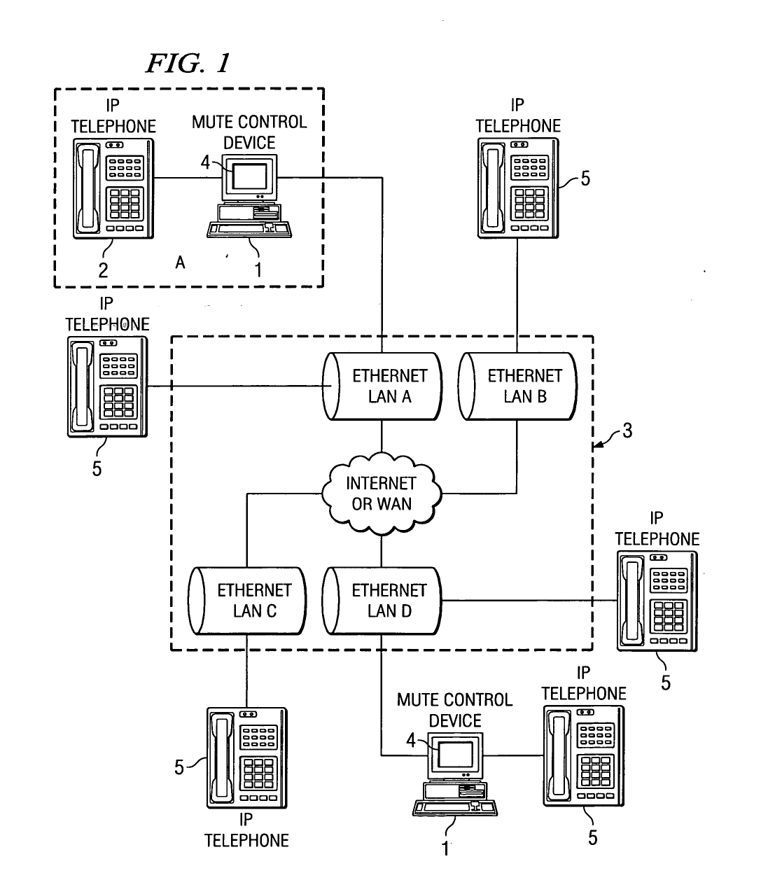

As shown in FIG. 1, in a first embodiment of the method of the present invention, a mute control device (MCD) 1 at a first location A is operatively connected to a digital telephone 2 (IP phone) and a packet-based (Ethernet, WAN or Internet) telephone network 3. The MCD 1 is an electronic telephony device comprising a digital signal processor, a user interface mechanism and a system status display mechanism 4. Additional IP communication devices, such as additional IP telephones 5 exist at other terminals of the operative network. Telephony software associated with MCD 1 enables said device to interface with IP phone 2 and network 3 in a manner that enables multi-party muting of selected conference call participants' telephones.

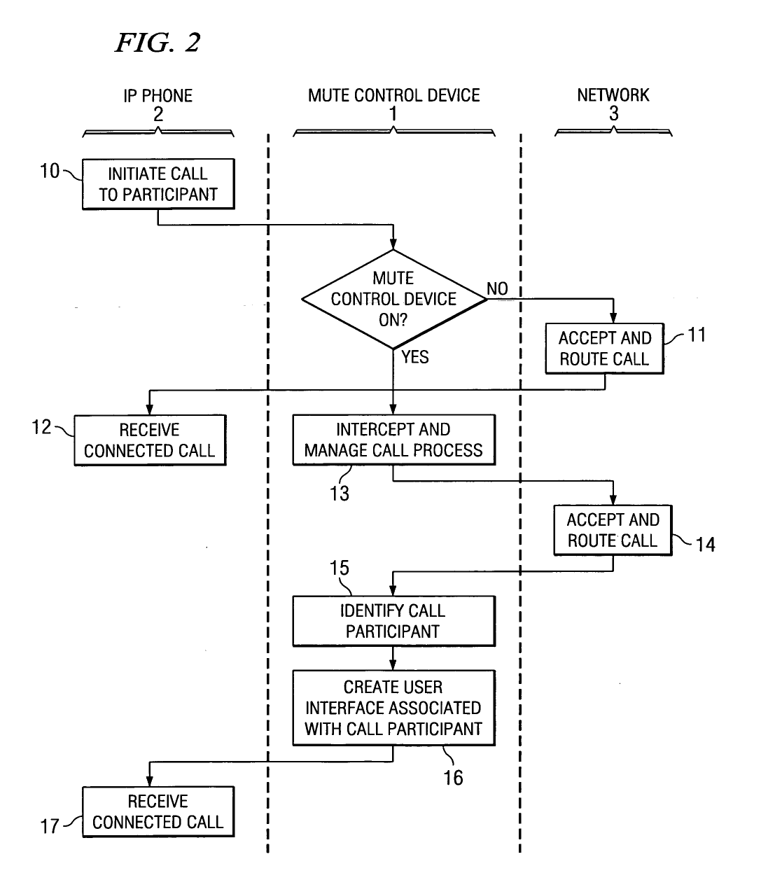

As illustrated in FIG. 2, a call is initiated 10 to an intended participant (any 5) by the user of IP phone 2 operatively connected to MCD 1 at first location A. If MCD 1 is not operative, network 3 processes the call 11 as it would for any normal packet-based call from that extension. The call is completed and the connection is received 12 by IP phone 2 at location A.

However, if MCD 1 is made operative by the user, the processing of the call is intercepted by the MCD and control of the call is handled in conjunction with the MCD 13. Call processing is directed to network 3 for routing 14. Upon a connection completion signal from the network, the call routed back through the MCD where the identification of the call participant is established 15. The MCD then creates a user interface 16 associated with that call participant. Finally, the completed call signal is received 17 at IP phone 2. The call is now established between a user at first location A and the call participant at another location (any 5) on network 3.

The process of placing calls to additional conference call participants (any other 5) in the network continues as indicated in FIG. 2 until all desired participants are engaged in the call.

The scope and method of system interface management 13 between the MCD 1, the IP phone 2 and the network 3 may be implemented in any manner common to those skilled in the art of the design of digital signal processing systems. For example, the MCD may receive communication packets from the IP phone which it then processes into new packets for transmission to the network. MCD 1 may be designed to operate as a conference call moderating gateway, wherein all packets transmitted to and from all IP phones 2, 5 are routed through the MCD; or alternatively, a protocol may be developed or amended to allow the MCD to interface with an existing network gateway causing it to act as a user-controlled moderator of the conference call.

Call participant identification 15 may be accomplished via any suitable system employed on the network 3. For example, any widely used IP phone signaling protocol will have defined a method to pass caller identification information between the parties involved in a call. The mute control system (MCD and call management software) will latch onto such identification information for the purposes of mute control management. Either this method or others producing a similar result may be employed without departing from the inventive concept herein described.

The user interface 16 maintained by MCD 1 facilitates the mute management capability for the connection. The interface allows the user of IP phone 2 to select one or a plurality of the participants engaged in the conference call to be muted. Muting is accomplished when the audible signal to one or more participants' IP phone is temporarily blocked, thus preventing said phones from receiving signals and disenabling such participant(s) from being able to hear what is being said by the remainder of the participants. Muting may also include preventing audible signals sent by muted participants' IP phones from being received by non-muted participants' phones without departing from the teachings of the inventive method herein taught.

In an exemplary methodology for the means of selection of participants to be muted, the user interface mechanism of the MCD 1 may comprise a touch-controlled screen, which may display visual “buttons”, with each button corresponding to one of a plurality of call participants. The user touches the button(s) associated with those participant(s) to be muted, rendering such participant(s) unable to hear what is being said by all other non-muted participants. Simultaneously, the non-muted participants may also be prevented from hearing sound originating at the location of the muted participant(s).

The MCD screen 4 indicates the current mute status of participants' telephones on the conference call. This indication may comprise an alpha numeric indication or any other suitable methodology.

In an alternative embodiment of the selection methodology, the MCD may be a device comprising a screen and a bank of physical buttons. Each button may be identified by a number. Call participants may be identified adjacent to these numbers in any form supported by the network's caller identification system, or any mute control device enhancement thereto. In another alternative, the user interface may include a keyboard and mouse. Yet another alternative employs the keypad of the digital phone to control the associated MCD. That is, the IP phone itself contains the user-interface to perform selective muting, sending messages to the MCD to perform these functions. In this alternative, the MCD may be situated at a “call center”, to which callers call into to participate in a conference call. This would enable each party to the call to send call muting commands via the IP phone to the MCD. Although the exemplary embodiment is depicted with the above limited number of optional means of participant selection methodology, any other means of user interface may be employed without departing from the scope of the invention.

In a second embodiment of the present invention, the MCD may be integrated with a digital telephone, the two units being manufactured as a single user device.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

1. A method of enabling caller-controlled selective muting of participants on a conference call, comprising:
interconnecting a mute control device (MCD) with a telephone on a packet-based network;
providing protocols to enable a call participant identification;
utilizing a user interface to select at least one of a plurality of call participants for muting; and
providing a system interface to enable said selective muting by a user of said MCD.

2. The method of claim 1, wherein said mute control device further comprises:
controlling a transmission of communications over said packet network to achieve said selective muting of said call participants as selected at the user interface;
providing a user interface mechanism; and
providing a system status display mechanism.

3. The method of claim 1, wherein said providing protocols to enable said call participant identification comprises:
identifying each active participant on the conference call, and
passing said identification to said user interface.

4. The method of claim 1, wherein said utilizing said user interface comprises:
viewing active conference call participants,
selecting one or more of said active conference call participants to be muted, and
viewing one of a muted and non-muted status of said active conference call participants.

5. The method of claim 1, wherein said providing said system interface comprises:
intercepting a processing of a call originating from the user of said MCD, if the MCD is operative, and
enabling muting of selected communication devices using a packet-transmission control scheme as directed from the user interface.

6. The method of claim 1, wherein said muting comprises:
blocking temporarily, audible signals to one or more of said telephones, and
preventing audible signals sent by muted telephones from being received by non-muted phones.

7. The method of claim 2, wherein said providing said user interface
mechanism comprises:
indicating the identity of call participants, on a display mechanism, in conjunction with the user interface, and
providing a selection mechanism to allow a user of the MCD to physically select one of a plurality of call participants' communication devices for said muting.

8. The method of claim 2, wherein said providing a system status display mechanism comprises providing a mechanism indicating the mute status of each of the active call participants in conjunction with said system interface.

9. The method of claim 1, wherein said packet network terminates at two or more IP communication devices used by participants on said caller-controlled conference call.

10. The method of claim 1, wherein said telephone comprises an Internet Protocol (IP) phone.
